(19) United States
(12) Patent Application Publication
(10) Pub. No.: US 2010/0237810 A1
(43) Pub. Date: Sep. 23, 2010

(54) METHOD AND CONTROLLER FOR CONTROLLING AN IPM MOTOR

(75) Inventors: Peter Scavenius Andersen, Soenderborg (DK); Carsten Rothmann, Krusaa (DK); Niels Pedersen, Toender (DK)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 12/707,867

(22) Filed: Feb. 18, 2010

(30) Foreign Application Priority Data
Feb. 20, 2009 (DK) PA 2009 00233

(51) Int. Cl. H02P 6/18

(52) U.S. Cl. 318/400.13; 318/400.35

(57) ABSTRACT

The present invention relates to a method for sensorless control of a permanent magnet motor exhibiting saliency, the method comprising the steps of determining a back electromotive force signal of a non-conducting phase winding of the permanent magnet motor, and applying a first drive voltage to at least one other phase winding of the permanent magnet motor, said first drive voltage being phase-shifted relative to the determined back electromotive force signal. Moreover, the present invention relates to a control system for carrying out the above-mentioned method.

### CROSS REFERENCE TO RELATED APPLICATION

Applicant hereby claims foreign priority benefits under U.S.C. §119 from Danish Patent Application No. PA 2009 00233 filed on Feb. 20, 2009, the contents of which are incorporated by reference herein.

### FIELD OF THE INVENTION

The present invention relates to a method and a control system for utilisation of the reluctance torque of interior permanent magnets (IPM) motor. This is accomplished by ensuring that drive currents lead the associated determined back electromotive force signals.

### BACKGROUND OF THE INVENTION

A well-proven concept for controlling a 3-phase permanent magnet motor is the so-called sensorless brushless DC scheme. In this scheme, the control operates with two of the motor phases conducting currents and one phase inactive at any given time. The inactive phase is used for detecting the moment in time that the induced phase back electromotive force (EMF) crosses zero. This principle is denoted zero-crossing detection. The EMF provides a rotor position feedback to the control, which is in turn used to generate the next commutation in a pre-defined manner. The detection of the EMF zero-crossing can, however, only be achieved when the motor phase in consideration has finished its current switch-off transient which is also known as demagnetisation.

Usually motors of the above type use surface-mounted permanent magnets (SPM). In SPM motors the rotor has very little, if any, saliency. Therefore, to ensure maximum torque per unit current fed into the motor, the control should aim at aligning the current in phase with the EMF. This is sketched in FIG. 1, showing three ideal phase currents (I) and EMFs (E) as well as the instants D (current switch-off transient), Z (zero-crossing) and C (next commutation) for one phase.

In contrast to SPM motors, the IPM motor is attractive since it allows the usage of magnets with simple geometric shapes. These could be of the rare-earth type, resulting in a motor with high torque density. Usually the motors of this type are run with a frequency converter using vector-based observers, thus relying on a mathematical model of the motor, and operating the motor with sinusoidal voltages and currents.

IPM motors usually have magnetic saliency which gives rise to an additional torque component, namely the reluctance torque. Unlike motors using SPM, the maximum torque per unit current in an IPM motor is achieved when the current and the EMF are not in phase. The phase displacement, often referred to as the “current advance angle” with the dedicated variable y (gamma), depends on the geometrical shape of the rotor as well as the operating point of the motor. Thus, vector-based control schemes vary y over the operating range to maximise the torque per unit current.

It is a disadvantage of known systems that vector-based control schemes are complex and require sophisticated hardware and software to operate. Thus, powerful processing as well as accurate current measurements are required in order to apply vector-based control schemes. For comparison, the control scheme relying on zero-crossing is much simpler and may be more stable in operation since it actually receives rotor position feedback, whereas the vector-based software must either rely on an encoder feedback signal or an observer-based control algorithm.

Known methods of the above type for controlling SPM motors are disclosed in various documents within the patent literature, such as for example EP 0 707 378, WO 2005/025050, U.S. Pat. No. 6,388,416 and U.S. Pat. No. 7,084,598.

It may be seen as an object of embodiments of the present invention to utilise the reluctance torque component of an IPM motor, and at the same time, apply a simple and stable control scheme which does not suffer from the drawbacks associated with traditional vector-based control schemes.

### SUMMARY OF THE INVENTION

The above-mentioned object is complied with by providing, in a first aspect, a method for sensorless control of a permanent magnet motor exhibiting saliency, the method comprising the steps of
determining a back electromotive force signal of a non-conducting phase winding of the permanent magnet motor, and
applying a first drive voltage to at least one other phase winding of the permanent magnet motor, said first drive voltage being phase-shifted relative to the determined back electromotive force signal.

The present invention may in principle be applied to motors of all sized, including small battery-driven motors and large motors of several kWs.

Thus, while a first drive voltage is applied to a phase winding of a permanent magnet motor in order to rotate the rotor of the motor, a back electromotive force signal is measured in another, non-conducting, phase winding of the permanent magnet motor. The back electromotive force signal is induced in the phase windings due to the relative movement between the phase windings and the permanent magnets of the motor.

The method may further comprise the step of determining at least one zero-crossing of the back electromotive force signal. The term zero-crossing is defined as the point where the measured back electromotive force signal equals zero volts.

Obviously, the first drive voltage induces an associated first drive current in the phase winding to which the drive voltage is applied. As the first drive voltage, or rather the fundamental hereof, advances the back electromotive force signal, the fundamental of the associated first drive current advances the back electromotive force signal as well.

The fundamental of the first drive current may advance the back electromotive force signal by 2-20 electrical degrees, such as by 8-12 electrical degrees.

The present invention may further comprise the step of applying a second drive voltage to yet another phase winding of the permanent magnet motor.

The first and second drive voltages may be applied to the phase windings as first and second commutation pulses. Ideally, these commutation pulses are shaped as rectangular pulses.

Preferably, the second drive voltage is applied while the first drive voltage is still active whereby a temporary overlap between the first and second drive voltages is established. The duration of temporary overlap between the drive voltages may be varied to fulfil specific demands. Thus, the duration of the temporary overlap may equal one third of the durations of the drive voltages. Thus, the first and second drive voltages and their associated drive currents or rather, the fundamentals hereof, may be phase-shifted approximated 60 electrical degrees relative to each other.

Again, the second drive voltage and an associated second drive current, or rather, the fundamental hereof, advance the back electromotive force signal by 2-20 electrical degrees, such as by 8-12 electrical degrees.

As described elsewhere in the present text additional drive voltages (commutation pulses) may be applied to the permanent magnet motor in order for it to rotate. In case of a three phase permanent magnet motor only two phase windings will, at any time, be exposed to drive voltages. The remaining and non-conductive phase winding will, at all times, be used to measure the back electromotive force signal.

The speed of rotation of the IPM motor typically varies with the frequency of the applied drive pulses. Thus, the higher the frequency the higher the speed of rotation. In steady-state conditions the duration of the pulses forming the drive voltages are equal.

The phase-shifting between the drive pulses and the determined back electromotive force signal may be dependent on a mechanical load provided on the IPM motor. Thus, if the mechanical load on the motor is increased for some reason, the phase-shifting is increased accordingly.

In a second aspect, the present invention relates to a control system for sensorless control of a permanent magnet motor exhibiting saliency, the control system comprising
means for determining a back electromotive force signal of a non-conducting phase winding of the permanent magnet motor, and determining at least one zero-crossing of said back electromotive force signal, and
drive means adapted to apply a first drive voltage to at least one other phase winding of the permanent magnet motor, said first drive voltage being phase-shifted relative to the determined back electromotive force signal.

Moreover, the drive means may be adapted to apply a second drive voltage to yet another phase winding of the permanent magnet motor, said second drive voltage being phase-shifted relative to the determined back electromotive force signal.

First and second drive currents are associated with the first and second drive voltages respectively, said first and second drive currents, or rather, fundamentals hereof, both advancing the determined back electromotive force signal. The first and second drive currents advance the back electromotive force signal by an amount as described in connection with the first aspect of the present invention. Also, the first and second drive currents are mutually phase-shifted as described in connection with the first aspect.

### BRIEF DESCRIPTION OF THE DRAWINGS

The present invention will now be explained in further details with reference to the accompanying drawings, wherein

FIG. 1 shows in-phase drive currents according to prior art,

FIG. 2 shows leading drive currents according to an embodiment of the present invention,

FIG. 3 shows a calculation of the electromagnetic torque of a prior art system, and

FIG. 4 shows a calculation of the electromagnetic torque of a system according to the present invention.

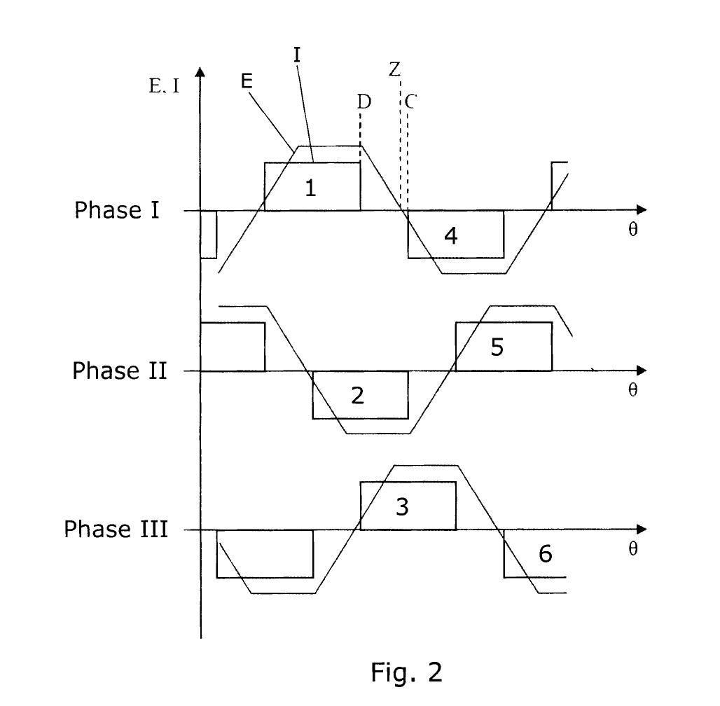

While the invention is susceptible to various modifications and alternative forms, a specific embodiment has been shown by way of examples in FIGS. 2-4 and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE PREFERRED EMBODIMENTS

As previously mentioned, vector-based control schemes are complex and require sophisticated hardware and software to operate. Thus, powerful processing as well as accurate current measurements are required if vector-based control schemes are to be applied.

For comparison, a control scheme relying on zero-crossing is much simpler and may be more stable in operation, since it actually receives rotor position feedback, whereas the vector-based software must either rely on an encoder feedback signal or an observer-based control algorithm.

The present invention suggests combining a control scheme based on zero-crossing, with a rotor having magnetic saliency.

Compared to known techniques, the present invention offers several advantages. Thus, by combining the knowledge of motor control based on EMF zero-crossings with current advance suitable for IPM motors, the following advantages can be achieved:
magnets with a simpler geometric form can be applied,
utilisation of a simple and robust control scheme for PM motors,
improved efficiency due to the utilisation of reluctance torque and decreased iron losses, and
improved control stability due to a longer demagnetisation time of the conducting phase.

In practice, the present invention is implemented by reducing the time interval between the zero-crossing of the back EMF and the following commutation. In FIG. 2 the point of zero-crossing of the back EMF is denoted Z, whereas the point of the next commutation is denoted C. The present invention facilitates that more torque per unit current is provided. Moreover, it is an advantage of the present invention that the time interval between D and Z is increased thus allowing a larger demagnetisation time of the phase after current switch off.

FIG. 2 illustrates idealised drive currents (1-6) of a IPM motor having three phases. As depicted in FIG. 2 drive currents are only applied to two phases at a time since the drive currents are applied in the following manner:

Drive current 1 is applied to phase I. Drive current 1 is followed by drive current 2 which is applied to phase II. Drive current 1 and 2 overlap with an amount that equals half of the duration of each of the drive currents. Similarly, drive current 3 follows drive current 2—drive current 3 is applied to phase III. Again, a temporary overlap exists between drive current 2 and 3. Drive current 4, applied to phase I, follows drive current 3—again with a temporary overlap. Similarly, drive current 4 is followed by drive current 5 on phase II which is subsequently followed by drive current 6 on phase III. As depicted in FIG. 2 two drive currents are active at all times. The non-conducting phase is, at all times, used for measuring the generated back EMF.

As shown in FIG. 2 the applied drive currents and the measured back EMF are phase shifted relative to each other in that the drive currents associated with the respective drive voltages advance the measured back EMF by 2-20 electrical degrees, such as by 8-12 electrical degrees.

In FIG. 2 one mechanical revolution of the motor corresponds to 720 electrical degrees, i.e. two electrical revolutions. Thus, for each mechanical revolution 12 commutations are applied. For an IPM motor having four poles the commutation frequency should be between 800 Hz and 1600 Hz if the speed of rotation of the motor should be variable between 2000 and 4000 rpm.

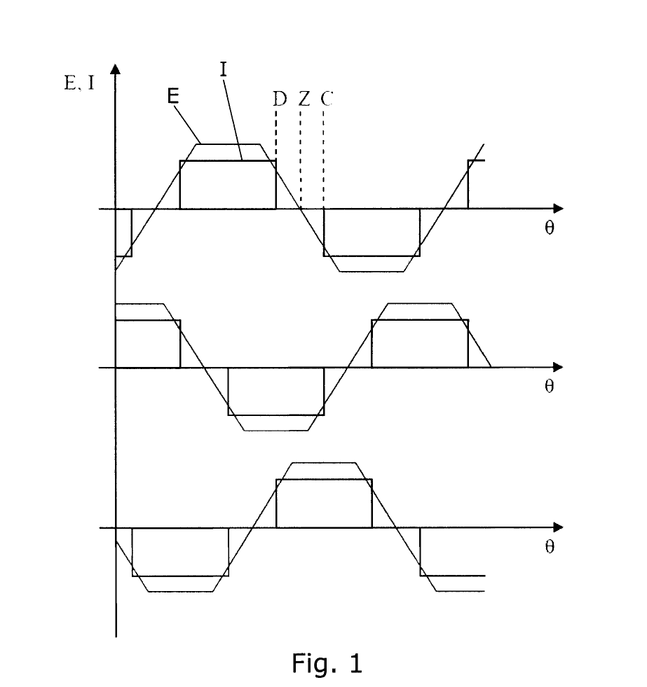

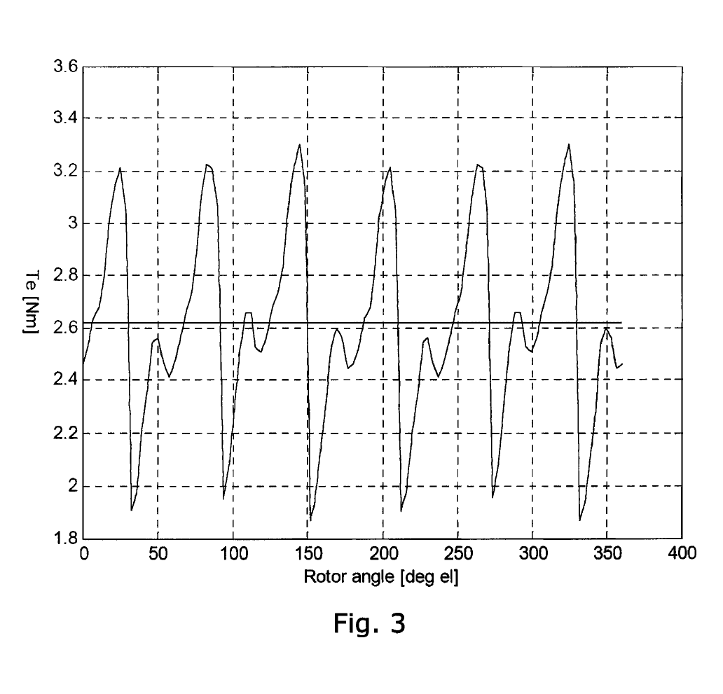

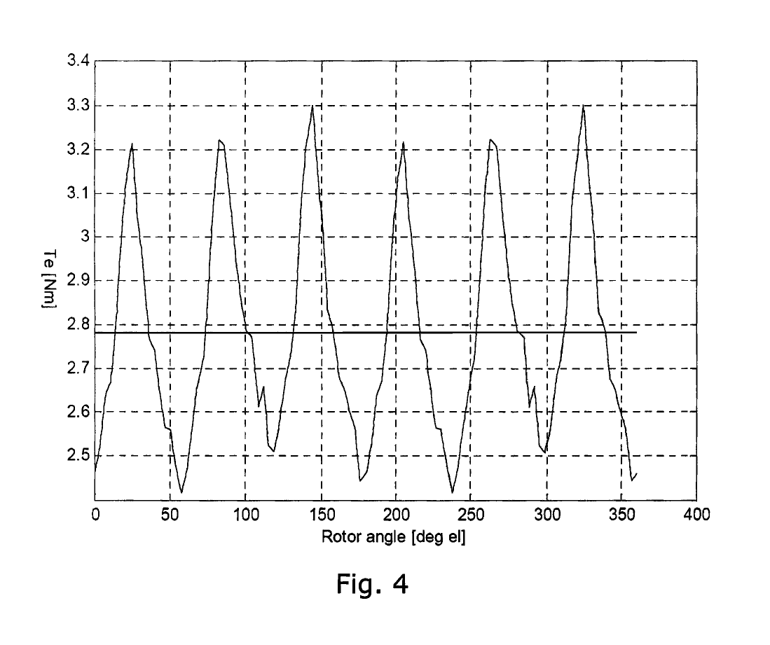

The increase in torque per unit current as a result of shortening the time interval between Z and C can be shown by Finite Element Analysis (FEA) calculations. FIG. 3 shows the calculated electromagnetic torque Te through an electrical cycle. The currents are ideal quasi-square waves aligned in phase with the back EMF as shown in FIG. 1. For comparison, FIG. 4 shows the same, where the only changed condition is that the current has been phase shifted 12 electrical degrees in advance of the back EMF.

It is seen that advancing the current has increased the average electromagnetic torque from 2.61 Nm to 2.79 Nm corresponding to a torque increase of around 7%. Since this is achieved at the same current, and hence the same copper losses, the efficiency is improved accordingly. Moreover, a component of the current will work to suppress the magnetic field from the rotor, thus reducing the stator flux density and lowering the iron losses. This further improves the efficiency of the motor.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A method for sensorless control of a permanent magnet motor exhibiting saliency, the method comprising the steps of:
determining a back electromotive force signal of a non-conducting phase winding of the permanent magnet motor, and
applying a first drive voltage to at least one other phase winding of the permanent magnet motor, said first drive voltage being phase-shifted relative to the determined back electromotive force signal.

2. The method according to claim 1, further comprising the step of determining at least one zero-crossing of the back electromotive force signal.

3. The method according to claim 1, wherein the first drive voltage and an associated first drive current advances the back electromotive force signal.

4. The method according to claim 3, wherein a fundamental of the first drive current advances the back electromotive force signal by 2-20 electrical degrees, such as by 8-12 electrical degrees.

5. The method according to claim 1, further comprising the step of applying a second drive voltage to yet another phase winding of the permanent magnet motor.

6. The method according to claim 5, wherein the second drive voltage and an associated second drive current advances the back electromotive force signal.

7. The method according to claim 6, wherein a fundamental of the second drive current advances the back electromotive force signal by 2-20 electrical degrees, such as by 8-12 electrical degrees.

8. The method according to claim 6, wherein the fundamentals of the first and second drive currents are phase-shifted relative to each other.

9. The method according to claim 8, wherein the fundamentals of the first and second drive currents are phase-shifted by approximately 60 electrical degrees.

10. A control system for sensorless control of a permanent magnet motor exhibiting saliency, the control system comprising:
means for determining a back electromotive force signal of a non-conducting phase winding of the permanent magnet motor, and determining at least one zero-crossing of said back electromotive force signal, and
drive means adapted to apply a first drive voltage to at least one other phase winding of the permanent magnet motor, said first drive voltage being phase-shifted relative to the determined back electromotive force signal.

11. The control system according to claim 10, wherein the drive means is adapted to apply a second drive voltage to yet another phase winding of the permanent magnet motor, said second drive voltage being phase-shifted relative to the determined back electromotive force signal.

12. The control system according to claim 11, wherein first and second drive currents are associated with respective ones of the first and second drive-voltages, wherein fundamentals of said first and second drive currents both advance the determined back electromotive force signal.
